(19) United States
(12) Patent Application Publication
(10) Pub. No.: US 2003/0095489 A1
(43) Pub. Date: May 22, 2003

(54) Optical disk and optical disk drive

(76) Inventors: Tadashi Kobayashi, Chiba-shi (JP); Kazuo Watabe, Yokohama-shi (JP)

Correspondence Address: PILLSBURY WINTHROP, LLP, P.O. BOX 10500, MCLEAN, VA, 22102, US

(21) Appl. No.: 10/233,785

(22) Filed: Sep. 4, 2002

(30) Foreign Application Priority Data
Nov. 21, 2001 (JP) 2001-356237

(51) Int. Cl. G11B 7/0045; G11B 7/24

(52) U.S. Cl. 369/59.25; 369/275.3

(57) ABSTRACT

An optical disk comprises a prepit head data recording area surrounded by non-record areas in a radial direction and a circumferential direction of the optical disk, and a data record track specified by prepit header data recorded on the prepit head data recording area.

### CROSS-REFERENCE TO RELATED APPLICATIONS

This application is based upon and claims the benefit of priority from the prior Japanese Patent Application No. 2001-356237, filed Nov. 21, 2001, the entire contents of which are incorporated herein by reference.

### BACKGROUND OF THE INVENTION

1. Field of the Invention

The present invention relates to an improvement of a recording format of a large-capacity optical disk. This invention also relates to an optical disk drive for recording data on a large-capacity optical disk in accordance with an improved recording format. Furthermore, this invention relates to an optical disk drive for reproducing, from a large-capacity optical disk, data that is recorded in the disk in an improved recording format.

2. Description of the Related Art

An example of the structure of tracks on a conventional optical disk will now be described. A plurality of groove tracks and a plurality of land tracks are alternately arranged on an optical disk in its radial direction such that each turn of the groove track is disposed adjacent to each turn of the land track. Each track slightly wobbles in the radial direction. The respective tracks are divided into a plurality of arcuated sectors, which are uniformly arranged in the radial direction of the optical disk. A header having address information, which identifies a record area, is disposed at the beginning of each arcuated sector. Headers are uniformly arranged in the radial direction.

For example, each track is about 0.6 μm wide, each groove track is about 60 nm deep, and each sector is about 6 mm long. Each sector has a capacity that is able to store 2048 bytes of user data. Each groove track and land track wobbles with an amplitude of about 20 nm in the radial direction of disk. The cycle of wobble is set at 1/232 of the length of the sector, i.e. about 25 μm. The radio of 1:232 is chosen such that the cycle of wobble is an integer number of times of the length of record data (i.e. channel bit length). This is because the recording clock can easily be generated from the wobble.

The header provided at the beginning of the track, that is, an identification (ID) information portion, will now be described. The ID information is arranged in a zigzag fashion in the circumferential direction of the optical disk. This zigzag arrangement can prevent the effect of crosstalk at the time of reading the ID information.

Address information contained in the ID information is recorded, for example, by a 8/16 modulation code (channel bit length=0.14 μm). The ID information is recorded by a small pit. The pit is formed in the process of forming groove tracks at the time of manufacture of the optical disk. A phase-change recording film (GeSbTe), for instance, is used as a recording film of the optical disk. Record marks (amorphous areas) are formed on the phase-change recording film.

This prior art is described in detail, for example, in Japanese Patent No. 2,856,390.

In the above-described prior-art method of arranging the ID information, i.e. address information, the effect of crosstalk of ID information units arranged adjacent to each other in the radial direction can be eliminated. However, the effect of crosstalk cannot be avoided when information reproduction is performed under such a condition that two ID information units which are arranged on two tracks with one track interposed therebetween (i.e. two ID information units spaced apart in the radial direction with a distance corresponding to one track pitch) are included in one beam spot. This condition tends to occur when a two-layer optical disk is reproduced. More specifically, when a beam spot is focused on one of the two recording layers, such an undesirable condition tends to occur in connection with a beam spot formed on the other recording layer. The reason is that the beam spot formed on said other recording layer is not focused. As a result, the beam spot on said other recording layer blurs and enlarges and is simultaneously subjected to the effect of plural tracks. The problem in this case is that plural ID information units are included in one beam spot at the same time.

A similar problem due to different beam spots formed on the two recording layers may occur when a data record area and a data non-record area are mixedly present on the disk. For example, when a beam spot has shifted from a substantially recorded area to a substantially non-recorded area, the reflectance and transmittance of the beam spot will greatly vary. This results in a decrease in reproduction precision.

### BRIEF SUMMARY OF THE INVENTION

An object of the present invention is to provide an optical disk having a recording format that can prevent degradation in quality of a reproduced signal.

According to an aspect of the present invention, there is provided an optical disk comprising: a prepit head data recording area surrounded by non-record areas in a radial direction and a circumferential direction of the optical disk; and a data record track specified by prepit header data recorded on the prepit head data recording area.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows an arrangement of tracks and header regions on an optical disk (of a land-and-groove recording type) according to a first embodiment of the present invention;

FIG. 2 illustrates focusing of a light beam on an optical disk having two information recording layers;

FIG. 3 illustrates a state in which a defocused beam spot scans an information recording layer;

FIG. 4 illustrates a state in which a defocused beam spot scans an information recording layer including recorded areas and non-recorded areas in a mixed fashion;

FIG. 5 illustrates an arrangement of divided prepit headers representing ID information in the first embodiment of the invention;

FIG. 6 shows an arrangement of tracks and header regions on an optical disk (of a groove recording type) according to a second embodiment of the present invention;

FIG. 7 illustrates an arrangement of divided prepit headers representing ID information in the second embodiment of the invention;

FIG. 8 illustrates an arrangement of header regions over one track;

FIG. 9 shows signal level of reproduced signals obtained when the first recording layer of the optical disk with two recording layers is reproduced;

FIG. 10 shows a state in which user data (=−content data) is recorded on groove tracks and land tracks immediately after header regions on the optical disk of the first embodiment;

FIG. 11 illustrates case 1-1 where user data is not recorded immediately after a header region on the optical disk of the first embodiment;

FIG. 12 illustrates case 1-2 where user data is not recorded immediately after a header region on the optical disk of the first embodiment;

FIG. 13 illustrates case 1-3 where user data is not recorded immediately after a header region on the optical disk of the first embodiment;

FIG. 14 illustrates case 1-4 where user data is not recorded immediately after a header region on the optical disk of the first embodiment;

FIG. 15 illustrates case 1-5 where user data is not recorded immediately after a header region on the optical disk of the first embodiment;

FIG. 16 illustrates case 2-1 where user data is not recorded immediately after a header region on the optical disk of the second embodiment;

FIG. 17 illustrates case 2-2 where user data is not recorded immediately after a header region on the optical disk of the second embodiment;

FIG. 18 illustrates case 2-3 where user data is not recorded immediately after a header region on the optical disk of the second embodiment;

FIG. 19 illustrates case 2-4 where user data is not recorded immediately after a header region on the optical disk of the second embodiment; and

FIG. 20 schematically shows the structure of an optical disk drive according to an example of the present invention.

### DETAILED DESCRIPTION OF THE INVENTION

A first embodiment of the present invention will now be described with reference to the accompanying drawings.

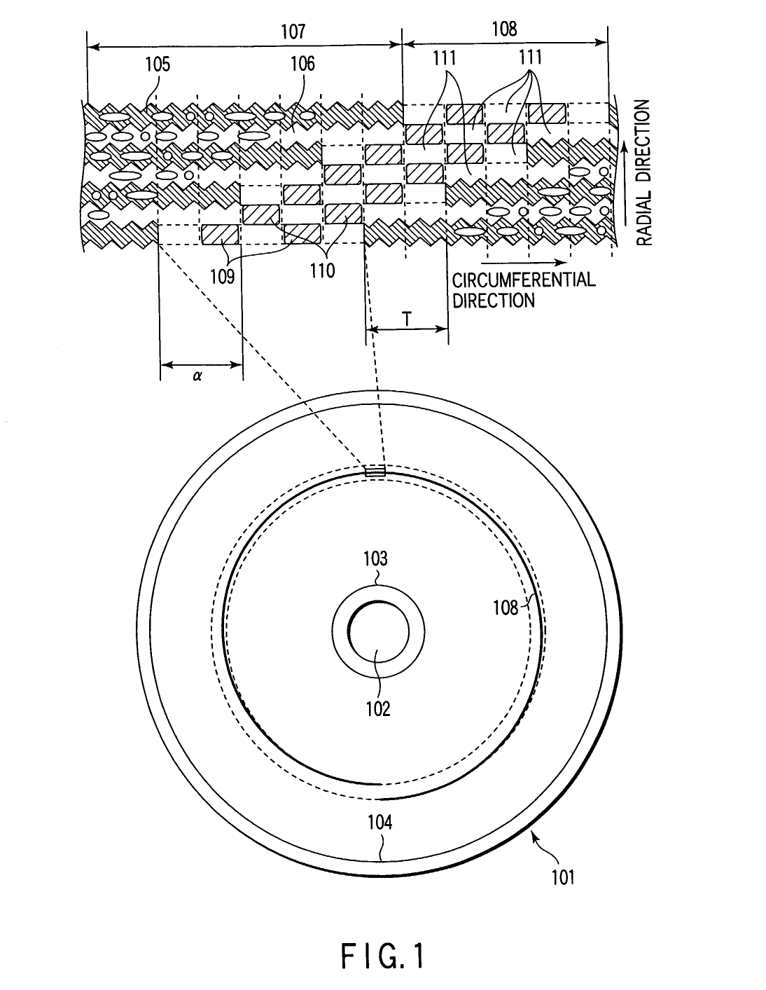

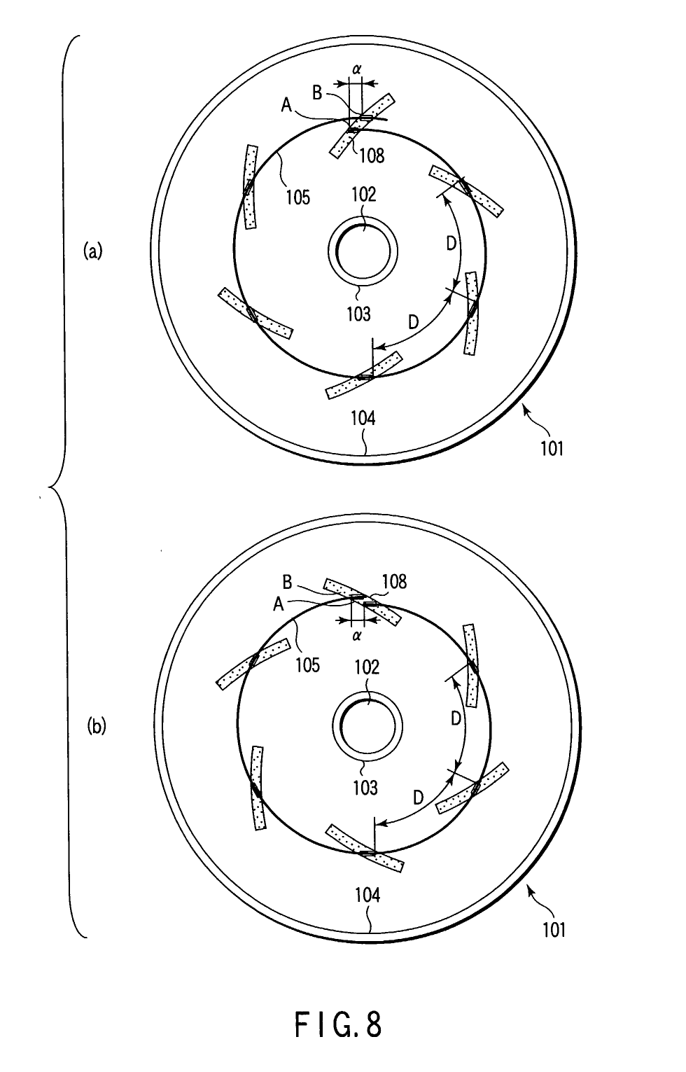

FIG. 1 shows an arrangement of tracks and header regions on an optical disk according to the first embodiment of the present invention. An optical disk 101 is a circular plate having a diameter of, e.g. 120 mm. The disk 101 has a hole 102 (e.g. 15 mm in diameter) at a central portion thereof for mounting on a disk driving motor. Spiral grooves are formed in a region between a radially innermost portion 103 (e.g. 48 mm in diameter) of a record region on the optical disk 101 and a radially outermost portion 104 (e.g. 116 mm in diameter) of the record region. Thereby, data recording/reproducing can be performed. An upper portion of FIG. 1 is an enlarged partial view of a recordable/reproducible region including an identification (ID) information portion (header data portion), i.e. a header region 108. The optical disk 101 described in this embodiment has a so-called land-and-groove recording format. Groove tracks 105, each having a physically recessed shape, and land tracks 106, each being disposed between adjacent two of the groove tracks 105, are arranged as information recording tracks on the disk 101. In other words, a groove track 105 of an n-th spiral turn adjoins a land track 106 of an (n+1)th spiral turn. The groove tracks 105 and land tracks 106 constitute a record region 107. Marks representing user data (or content data), which are formed by, e.g. phase change of the disk medium, can be recorded on the record region 107. Each groove track 105 is divided into user data record units, and ID information representing, e.g. the number assigned to each record unit, is recorded on an area (i.e. header region 108) next to the beginning of each record unit. This ID information is recorded in the form of a prepit 109 (110), which is a small recess or projection. Each prepit 109 (110) is surrounded by non-record areas in the circumferential direction and radial direction of the disk 101. Header regions 108 are arranged at substantially regular intervals D (mm) along the tracks, as shown in FIG. 8. In the case of portion (a) in FIG. 8, the length (the length of line AB) of one spiral turn of the groove track 105 is expressed by M=D−α (mm) (M is a positive integer; M=6 in FIG. 8; α is a real number), since the length from the beginning of a header region 108 to that of the next header region 108 is D (mm). Specifically, the header region 108 of the track of a given turn of the spiral is displaced by α (mm) from the header region 108 of the track of a preceding turn of the spiral. If the tracks on the optical disk 101 are formed such that any one of them meets this condition, the header regions 108 on the entire disk are not aligned in the radial direction and are gradually displaced. As a result, the header regions 108 are formed on the disk in a spiral shape different from the spiral of the groove tracks 105. Alternatively, as shown in portion (b) in FIG. 8, the length of one spiral turn of the groove track 105 may be set at M=D+α (mm). In this case, the direction of the spiral of header regions 108 on the disk is reverse to that in portion (a) in FIG. 8.

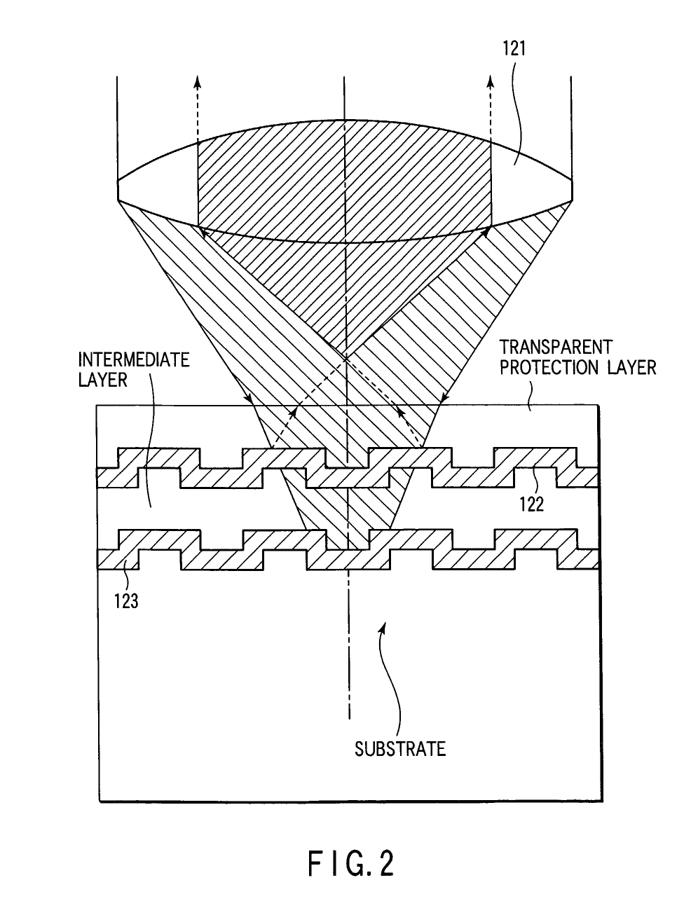

Referring to FIG. 2, consideration will now be given to the arrangement of tracks and header regions on an optical disk having, e.g. two information recording layers. Assume that a 0th recording layer 122 and a 1st recording layer 123 are stacked in the named order, as viewed from the side closer to an objective lens 121. A beam spot focused on the 1st recording layer 123 is not focused on the 0th recording layer 122 and blurs and enlarges (in the defocused state). Reflection light of the defocused beam spot formed on the 0th recording layer 122 enters the objective lens 121 along with reflection light of the focused beam spot on the first recording layer 123. The reflection light of the defocused beam spot constitutes a crosstalk component when information is recorded/reproduced. Accordingly, when the reflection light of the defocused beam spot on the 0th recording layer 122 varies greatly, precise information recording/reproducing is not performed and the recording/reproducing of information is substantially disabled.

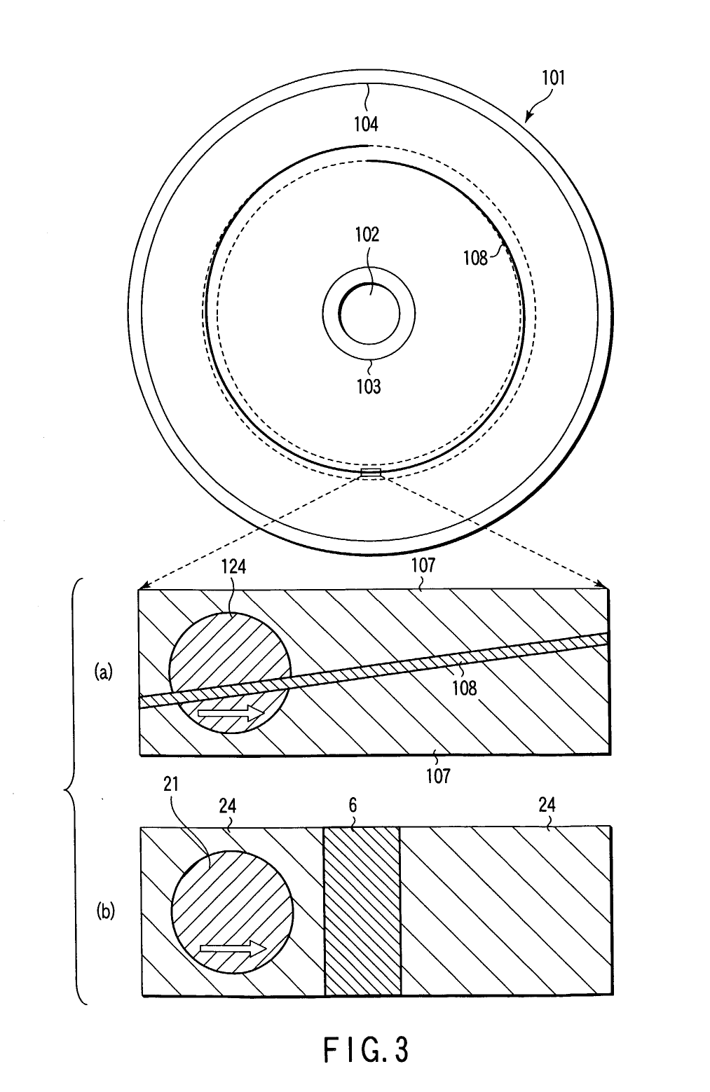

A case where a multi-layer optical disk has the header region arrangement shown in FIG. 1 will now be considered. Specifically, referring to FIG. 3, consideration will now be given to the information recording/reproducing on the 1st recording layer 123 of the optical disk where radially adjacent header regions are displaced by the amount α. Portion (a) of FIG. 3 shows a defocused beam spot on the 0th recording layer 122. As mentioned above, the header regions 108 are spirally formed on the optical disk (see an upper portion of FIG. 3). Thus, the header regions 108 do not occupy a large area of the defocused beam spot 124, and the defocused beam spot 124 gradually crosses the header regions 108. At this time, the amount of reflection light of the beam spot 124 does not greatly vary.

On the other hand, portion (b) of FIG. 3 shows a case of a conventional optical disk where header regions 6 are radially aligned. In this case, when the defocused beam spot 21 crosses the radially aligned header regions 6, a sharp change occurs in the amount of reflection light. When the beam spot 21 is on a record region 24, most of the area of the beam spot 21 is occurred by the record region 24. However, when the beam spot 21 shifts onto the header region 6, most of the area of the beam spot 21 is occupied by the header region 6.

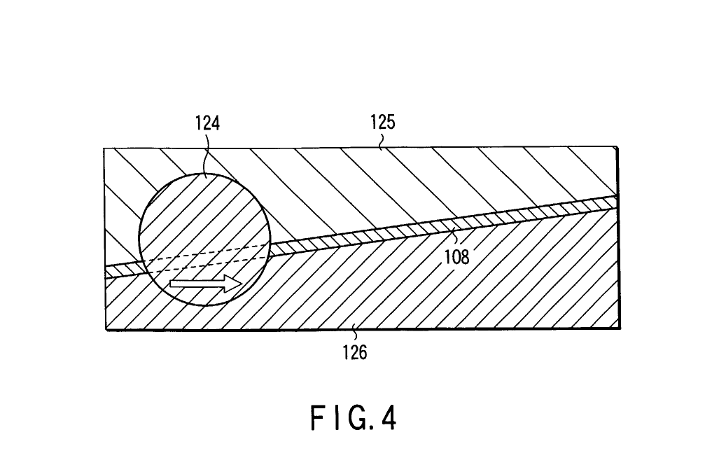

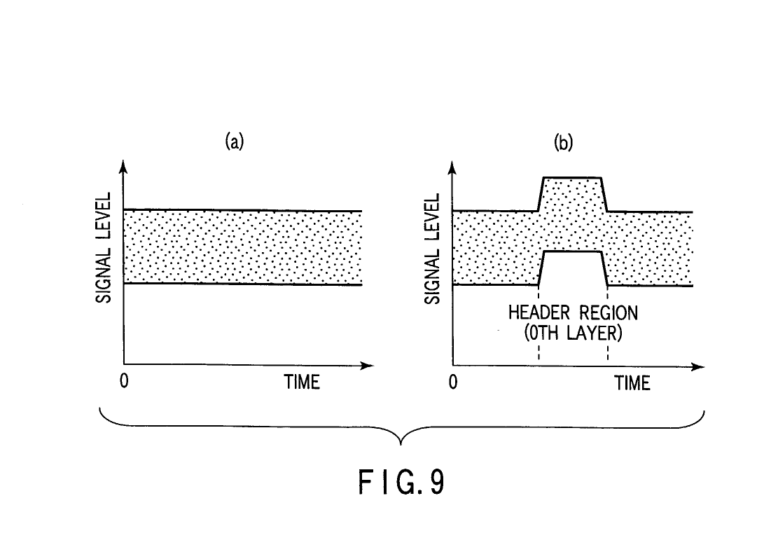

Portion (a) in FIG. 9 shows the level of the reproduced signal on the 1st recording layer 123 in the case shown in portion (a) in FIG. 3, and portion (b) in FIG. 9 shows the level of the reproduced signal on the 1st recording layer 123 in the case shown in portion (b) of FIG. 3. In the case of the optical disk adopting the header region arrangement of the present invention, no large variation occurs in the amount of reflection light from the 0th recording layer 122, and a stable signal level is maintained as shown in portion (a) in FIG. 9. On the other hand, in the case of the conventional optical disk, the amount of reflection light greatly varies when the defocused beam spot 21 on the 0th recording layer 122 crosses the header region 6. Thus, as shown in portion (b) in FIG. 9, the level of the reproduced signal on the 1st recording layer 123 greatly varies. As has been described above, the problem of crosstalk due to header regions in the prior art can be solved by the optical disk adopting the header region arrangement of the present invention. Moreover, the problem in the prior art occurring when recorded portions and non-recorded portions are mixedly present on the disk can be solved by the optical disk adopting the header region arrangement of the present invention. The reason is that the beam sport, as shown in FIG. 4, gradually moves from a region 125 including many recorded unit areas to a record region 126 essentially comprising non-recorded areas, and so, unlike the prior art, no sharp change in reflection will occur.

With the optical disk adopting the header region arrangement of this invention, the problem in the prior art is solved. That is, the beam spot, which is focused on one recording layer but defocused on the other recording layer, does not adversely affect this other recording layer. Therefore, information can first be developed into the two recording layers.

The arrangement of prepits in the header regions on the optical disk of the present invention will now be described. In FIG. 1, the ID information (header data) including the number assigned to the record unit is recorded as prepits on the header region 108 extending along each of the groove tracks 105 and land tracks 106. In this case, the prepit header 109 on the groove track 105 and the prepit header 110 on the land track 106 are circumferentially displaced. The reason is that if they were disposed radially adjacent to each other, crosstalk would occur due to signals from both prepit headers 109 and 110.

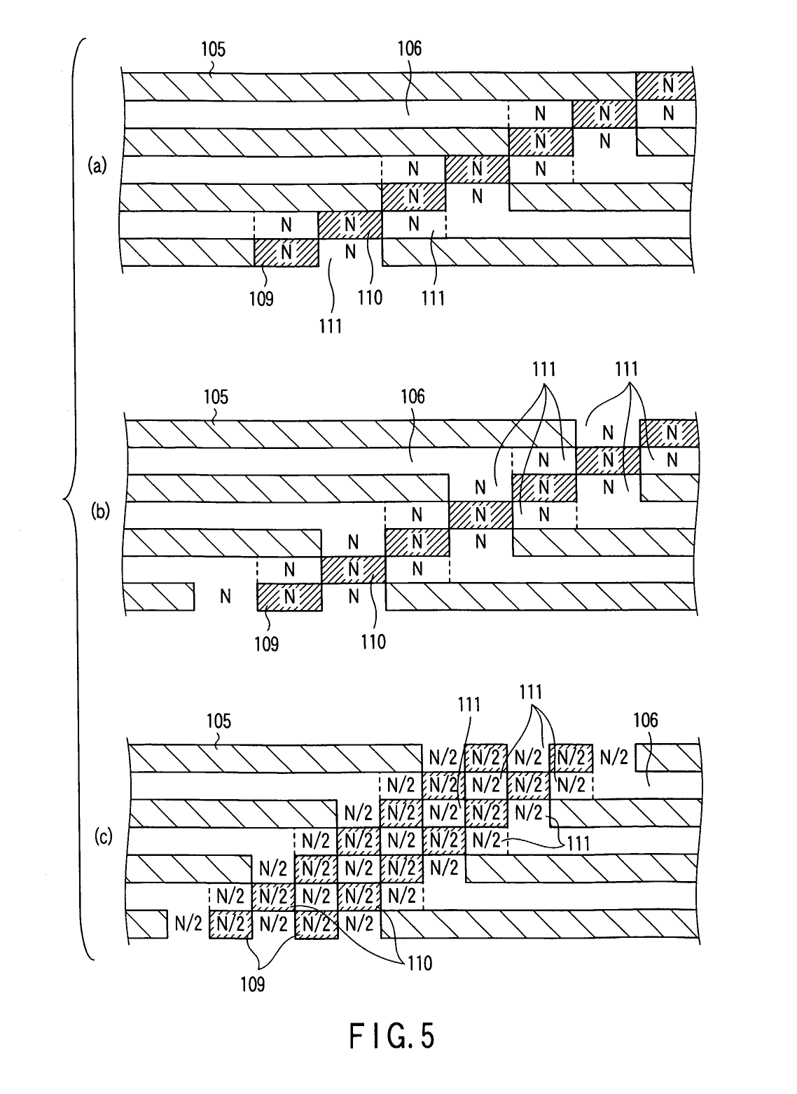

Portion (a) in FIG. 5 shows an example of the structure that meets this condition, wherein the length of the header region is reduced as much as possible. If the length of each of the prepit header 109 and prepit header 110 is set at N bytes, the length of an intervening area that splits each of the groove tracks 105 and land tracks 106 is 2N bytes. The 2N bytes intervening area comprises the prepit header 109 and a non-record area (land area) 111, or the prepit header 110 and a non-record area (groove area) 111. If the header regions 108 are formed in this fashion, however, the following problem occurs. The prepit header 109 on the groove is flanked on both sides with the land areas in the radial direction of the disk, whereas the prepit header 110 on the land adjoins the land area on one side in the radial direction of the disk but adjoins the groove area on the other side. In this case, it is easily expectable that amplitudes of reproduced signals from the prepit header 109 and prepit header 110 do not coincide. Thus, this arrangement of prepit headers is not preferable.

Portion (b) in FIG. 5 shows another example of the structure, wherein the intervening area that splits each of the groove tracks 105 and land tracks 106 is increased so that the prepit header is always flanked with non-record areas (land areas) 111 in the radial direction of the disk (as well as in the circumferential direction). In this case, when the prepit header 109 on the groove and the prepit header 110 on the land are reproduced, it is expected that substantially equal signal amplitudes are obtained from both prepit headers 109 and 110.

In the structure shown in portion (b) in FIG. 5, the length of the intervening area that splits each of the groove tracks 105 and land tracks 106 is 3N bytes. However, the effective information (ID information) in the header region of each track is only N bytes, and the other 2N bytes are redundant areas (non-record areas 111). According to the optical disk of the present invention, in order to reduce the redundant areas, a prepit header arrangement as shown in portion (c) in FIG. 5 is adopted. The number of each record unit contained in the ID information is, in most cases, repeated twice in order to enhance reading accuracy. Accordingly, the prepit header containing the ID information can physically be divided into two prepit headers which represent the same number assigned to the record unit. Thus, each of the prepit headers 109 on the grooves and prepit headers 110 on the lands is divided into two prepit headers, as shown in portion (c) in FIG. 5, such that the prepit headers 109 and the prepit headers 110 are displaced and alternately arranged in a staggered fashion. In other words, the prepit header 109 located in front of the groove track 105 of an n-th spiral turn adjoins in the radial direction the non-record area 111 located in front of the land track 106 of an (n+1)th spiral turn. The prepit header 110 located in front of the land track 106 of the (n+1)th spiral turn adjoins in the radial direction the non-record area 111 located in front of the groove track 105 of the n-th spiral turn. In this case, the length of each prepit header is N/2 bytes, and the length of the intervening area splitting each of groove tracks 105 and land tracks 106 is 2.5N bytes. Since the effective information (ID information) in the header region of each track remains N bytes and the same as before the division of the prepit header, the length of the redundant area is 1.5N bytes and is reduced by 25%. Therefore, the prepit header arrangement of the present invention can reduce the redundancy and increase the user data capacity.

The length of a single turn of the track, which has been described with reference to FIG. 8, is equal to one spiral turn of the groove track 105 or land track 106. Thus, when the prepit header arrangement shown in portion (c) in FIG. 5 is adopted, the amount α of displacement in each turn of the track is double the length of one prepit header (i.e. N bytes), as is understood from portion (c) in FIG. 5.

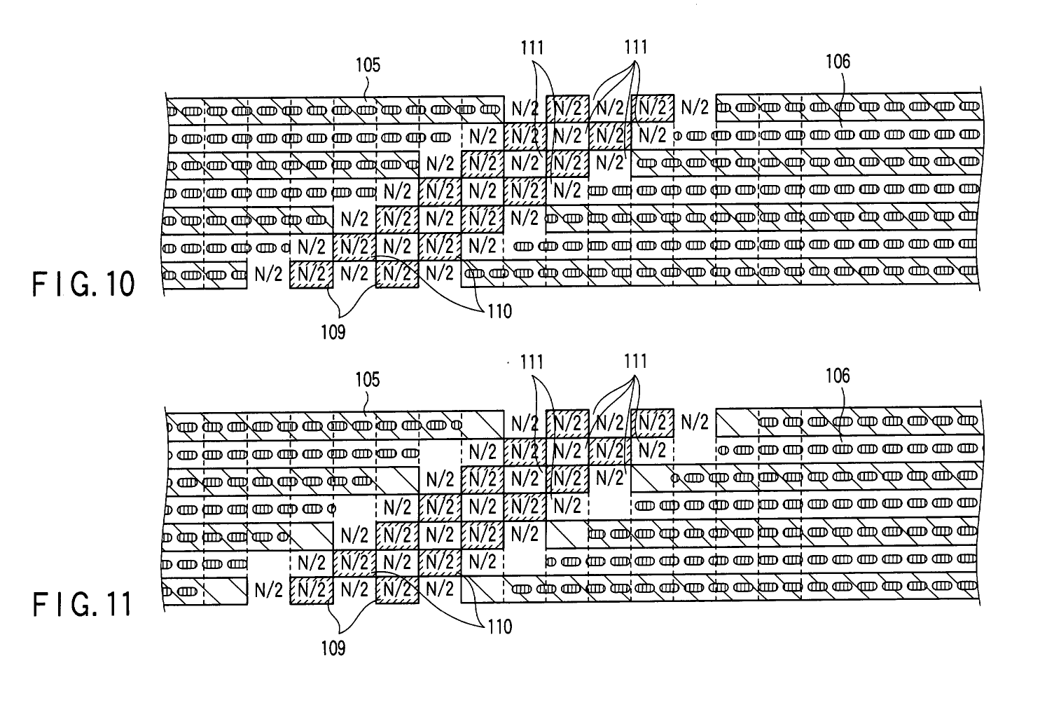

Referring now to FIGS. 10 to 15, a description will now be given of various cases of recording data on the groove tracks and land tracks.

FIG. 10 shows a state in which user data (=content data) is recorded on groove tracks and land tracks immediately after header regions on the optical disk of the first embodiment. The structure shown in FIG. 10 is advantageous in terms of recording efficiency since data can be recorded on groove tracks and land tracks immediately after the header regions. However, that portion of the land track, which is immediately after the header region, adjoins a non-record area (mirror area) 111 on one side in the radial direction, while adjoining the groove track on the other side. Consequently, reflection light from both side areas of this portion of the land track becomes unbalanced. Moreover, since the groove track is not present on one side of this portion of the land track, push-pull tracking is difficult to perform.

FIG. 11 illustrates case 1-1 where user data is not recorded immediately after a header region on the optical disk. In case 1-1, a recording start point is set at a location that is apart from the end of the header region on each of the groove track and land track by a predetermined distance (predetermined length T=α/2=N/2) in the circumferential direction of the disk. A recording end point is set at a location that is apart from the beginning of the header region by a predetermined distance (predetermined length T=α/2=N/2) in the circumferential direction. Thus, user data is recorded on the land tracks and groove tracks. In this case, it is possible to avoid the configuration that the recording start portion of the land track adjoins the non-record area (mirror area) 111 on one side alone in the radial direction. However, the timing of start of recording on both the land track and groove track is concurrent with the push-pull tracking. Consequently, it is expected that the recording and tracking state becomes unstable immediately after the start of recording.

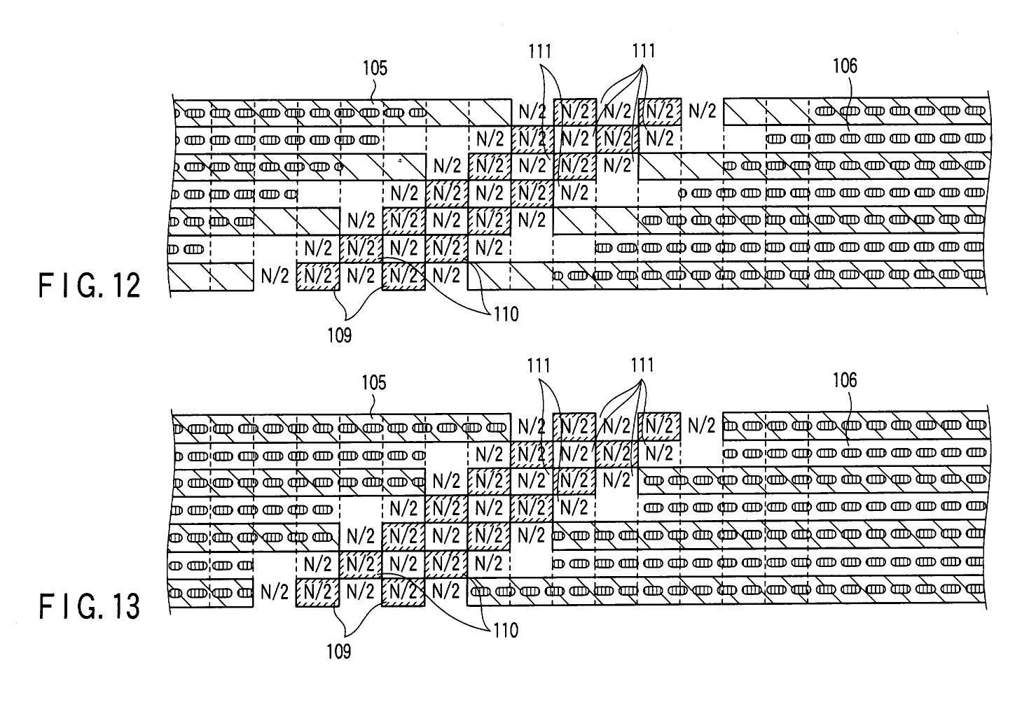

FIG. 12 illustrates case 1-2 where user data is not recorded immediately after a header region on the optical disk. In case 1-2, a recording start point is set at a location that is apart from the end of the header region on each of the groove track and land track by a predetermined distance (predetermined length T=α=N) in the circumferential direction of the disk. A recording end point is set at a location that is apart from the beginning of the header region by a predetermined distance (predetermined length T=α=N) in the circumferential direction. Thus, user data is recorded on the land tracks and groove tracks. In this case, too, it is possible to avoid the configuration that the recording start portion of the land track adjoins the non-record area (mirror area) 111 on one side alone in the radial direction. In addition, the timing of start of recording on both the land track and groove track is not concurrent with the push-pull tracking, and there is a time different therebetween. Thus, the recording and tracking state becomes stable immediately after the start of recording.

FIG. 13 illustrates case 1-3 where user data is not recorded immediately after a header region on the optical disk. In case 1-3, a recording start point is set at a location that is apart from the end of the header region on the land track by a predetermined distance (predetermined length T=α/2=N/2) in the circumferential direction of the disk. A recording end point is set at a location that is apart from the beginning of the header region on the land track by a predetermined distance (predetermined length T=α/2=N/2) in the circumferential direction. Thus, user data is recorded on the land track. On the other hand, a recording start point is set at a location that is immediately after the end of the header region on the groove track. A recording end point is set at a location that is immediately before the beginning of the header region on the groove track. Thus, user data is recorded on the groove track. In this case, it is possible to avoid the configuration that the recording start portion of the land track adjoins the non-record area (mirror area) 111 on one side alone in the radial direction. However, the timing of start of recording on both the land track and groove track is concurrent with the push-pull tracking. Consequently, it is expected that the recording and tracking state becomes unstable immediately after the start of recording.

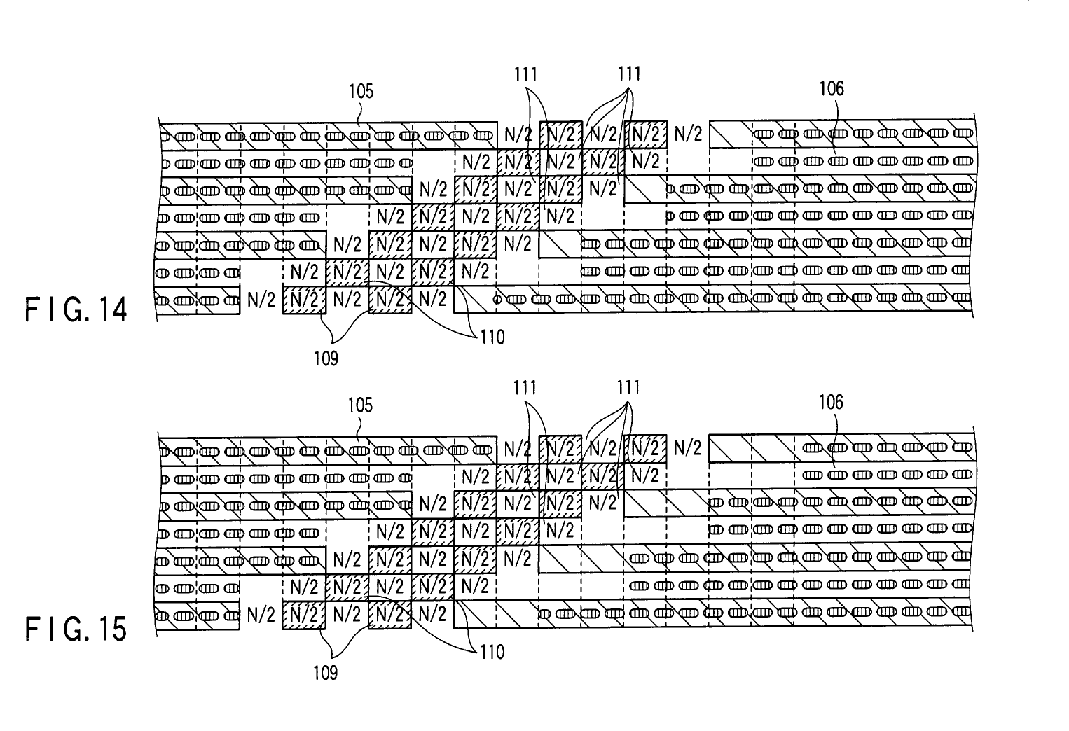

FIG. 14 illustrates case 1-4 where user data is not recorded immediately after a header region on the optical disk. In case 1-4, a recording start point is set at a location that is apart from the end of the header region on the land track by a predetermined distance (predetermined length T=α=N) in the circumferential direction of the disk. A recording end point is set at a location that is apart from the beginning of the header region on the land track by a predetermined distance (predetermined length T=α/2=N/2) in the circumferential direction. Thus, user data is recorded on the land track. On the other hand, a recording start point is set at a location that is apart from the end of the header region on the groove track by a predetermined distance (predetermined length T=α/2=N/2) in the circumferential direction of the disk. A recording end point is set at a location that is immediately before the beginning of the header region on the groove track. Thus, user data is recorded on the groove track. In this case, it is possible to avoid the configuration that the recording start portion of the land track adjoins the non-record area (mirror area) 111 on one side alone in the radial direction. In addition, the timing of start of recording on both the land track and groove track is not concurrent with the push-pull tracking, and there is a time different therebetween. Thus, the recording and tracking state becomes stable immediately after the start of recording. Furthermore, by determining the recording end points as described above, a decrease in recording capacity can be suppressed.

FIG. 15 illustrates case 1-5 where user data is not recorded immediately after a header region on the optical disk. In case 1-5, a recording start point is set at a location that is apart from the end of the header region on the land track by a predetermined distance (predetermined length T=1.5α=1.5N) in the circumferential direction of the disk. A recording end point is set at a location that is apart from the beginning of the header region on the land track by a predetermined distance (predetermined length T=α/2=N/2) in the circumferential direction. Thus, user data is recorded on the land track. On the other hand, a recording start point is set at a location that is apart from the end of the header region on the groove track by a predetermined distance (predetermined length T=α=N) in the circumferential direction of the disk. A recording end point is set at a location that is immediately before the beginning of the header region on the groove track. Thus, user data is recorded on the groove track. In this case, it is possible to avoid the configuration that the recording start portion of the land track adjoins the non-record area (mirror area) 111 on one side alone in the radial direction. In addition, the timing of start of recording on both the land track and groove track is not concurrent with the push-pull tracking, and there is a time different therebetween. Thus, the recording and tracking state becomes stable immediately after the start of recording. Furthermore, since the distance between the end of the header region and the recording start point is made greater than in case 1-4 (FIG. 14), tracking is made more stable. Moreover, by determining the recording end points as described above, a decrease in recording capacity can be suppressed.

A second embodiment of the present invention will now be described with reference to the accompanying drawings. In the first embodiment, user data is recorded on both the groove track and land track of the optical disk. In the second embodiment, user data is recorded on only the groove track of the optical disk.

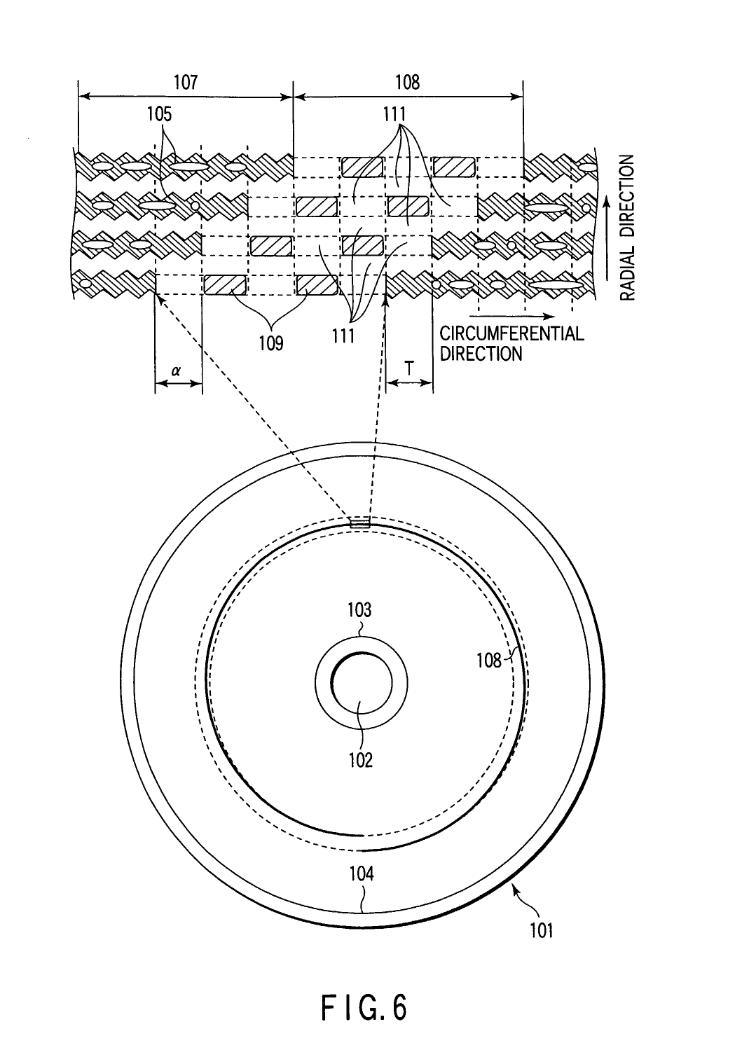

FIG. 6 shows an arrangement of tracks and header regions on the optical disk according to the second embodiment of the present invention. In the second embodiment, the optical disk has a so-called groove recording format, and only the groove tracks are used as information recording tracks. The optical disk of the second embodiment differs from that of the first embodiment shown in FIG. 1 in that only the groove tracks 105 are used as tracks for information recording/reproducing. Accordingly, the header regions 108 are provided on the groove tracks 105 alone. Each prepit 109 contained in the header region 108 is surrounded by non-record areas (land areas) in the circumferential direction and radial direction of the disk. Like the first embodiment, header regions 108 are arranged at substantially regular intervals D (mm) along the tracks. The relationship between the length of each spiral turn of the groove track 105 and the interval of header regions is also the same as that of the first embodiment shown in FIG. 8. The header region 108 of the track of a given spiral turn is displaced by α (mm) from the header region 108 of the track of a preceding spiral turn. As a result, like the first embodiment, the header regions 108 are formed on the disk in a spiral shape. Accordingly, the problem of crosstalk between the two information recording layers of the optical disk is solved, as is clear from the description of the first embodiment.

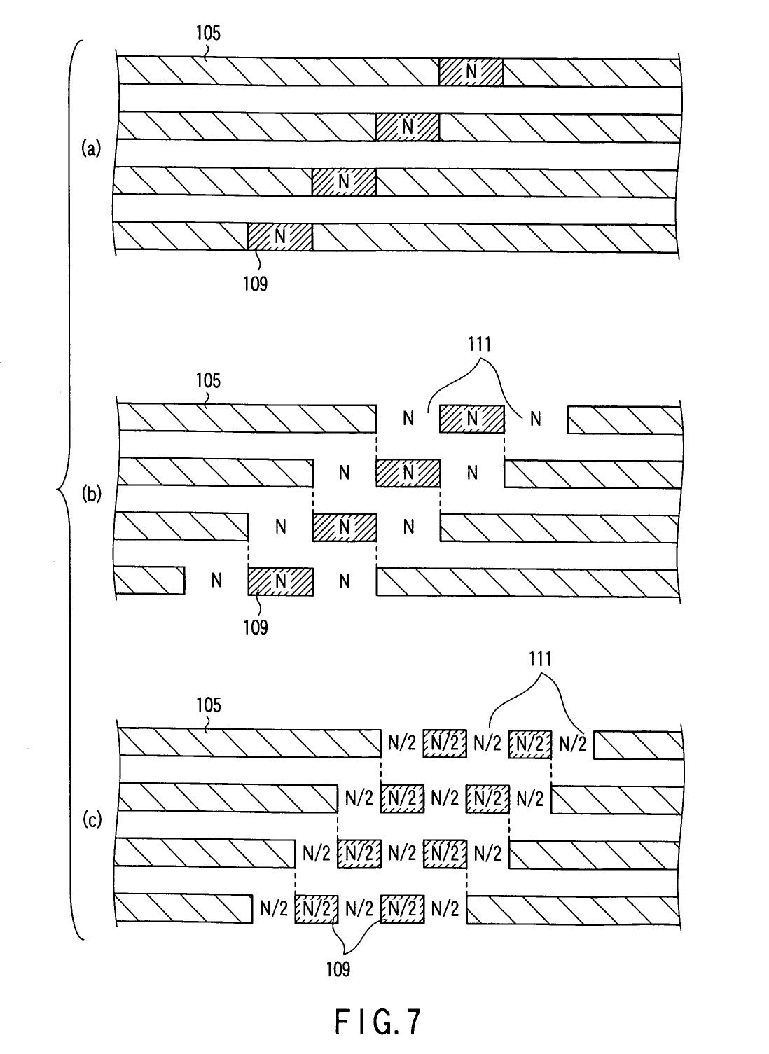

Referring now to FIG. 7, the arrangement of prepits in the header regions on the optical disk of the second embodiment will be described. Portion (a) in FIG. 7 shows an example of the structure wherein the prepit headers 109 are disposed on the groove tracks 105 alone and the length of the header region is reduced as much as possible. If the length of each prepit header 109 is set at N bytes, the length of an intervening area that splits each groove track 105 is N bytes. If the header region 108 is configured in this fashion, each prepit header 109 is disposed very close to adjacent groove tracks in the radial direction of the disk. In this case, it is easily expectable that a sufficient signal amplitude cannot be obtained from the prepit header 109. Thus, this arrangement of prepit headers is not preferable.

Portion (b) in FIG. 7 shows another example of the structure, wherein the intervening area that splits each groove track 105 is increased so that the prepit header is always flanked with non-record areas (land areas) 111 in the radial direction of the disk (as well as in the circumferential direction). In this case, when the prepit header 109 on the groove are reproduced, it is expected that a sufficient signal amplitude can be obtained. In the structure shown in portion (b) in FIG. 7, the length of the intervening area that splits each groove track 105 is 3N bytes. However, the effective information (ID information) in the header region of each track is only N bytes, and the other 2N bytes are redundant areas (non-record areas 111). According to the optical disk of the second embodiment, like that of the first embodiment, in order to reduce the redundant areas, a prepit header arrangement as shown in portion (c) in FIG. 7 is adopted. Specifically, the prepit header 109 is physically divided into two prepit headers which represent the same number assigned to the record unit. The prepit headers 109 on a groove track and those on an adjacent groove track are displaced and alternately arranged in a staggered fashion. In other words, the prepit header 109 located in front of the groove track 105 of an n-th spiral turn is disposed adjacent to the prepit header 109 located in front of the groove track 105 of an (n+2)th spiral turn, with the land area interposed therebetween. Similarly, the non-record area 111 located in front of the groove track 105 of the n-th spiral turn is disposed adjacent to the non-record area 111 located in front of the groove track 105 of the (n+2)th spiral turn, with the land area interposed therebetween. In this case, the length of each prepit header is N/2 bytes, and the length of the intervening area splitting each groove track 105 is 2.5N bytes. Since the effective information (ID information) in the header region of each track remains N bytes and the same as before the division of the prepit header, the length of the redundant area is 1.5N bytes and is reduced by 25%. Therefore, the prepit header arrangement of the second embodiment, like that of the first embodiment, can reduce the redundancy and increase the user data capacity.

When the prepit header arrangement shown in portion (c) in FIG. 7 is adopted, the amount α of displacement in each turn of the track is substantially the same as the length of one prepit header (i.e. N/2 bytes), as is understood from portion (c) in FIG. 7.

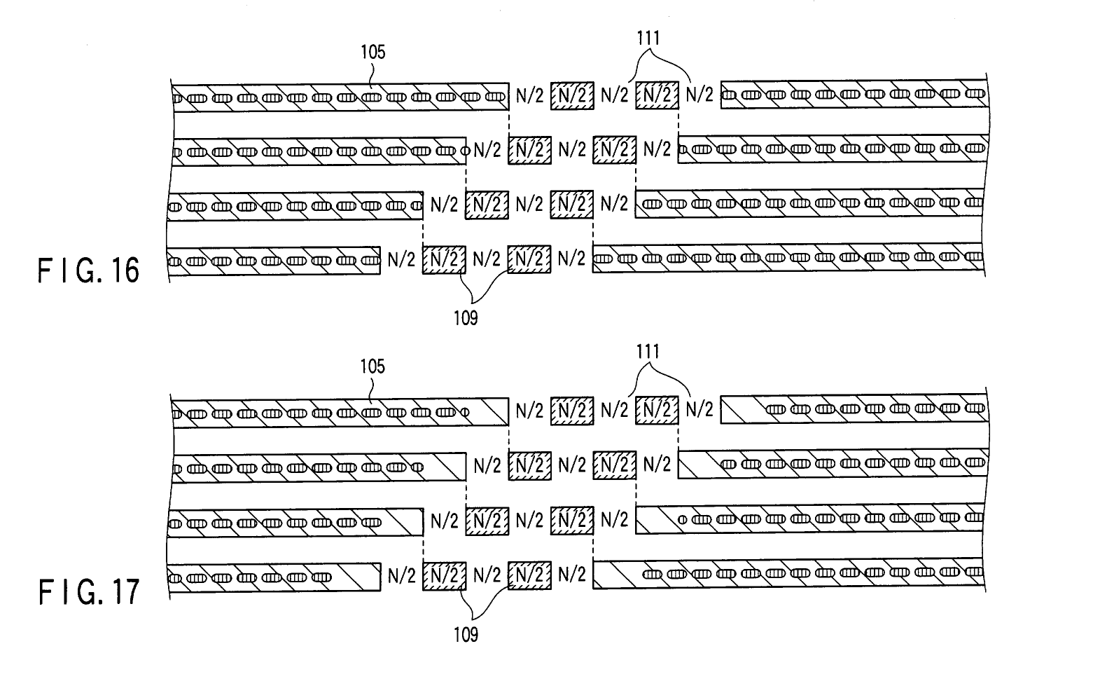

Referring now to FIGS. 16 to 19, a description will now be given of various cases of recording data on the groove tracks.

FIG. 16 shows case 2-1 where user data (=content data) is recorded on groove tracks immediately after header regions on the optical disk. In case 2-1, the recording start portion of the groove track, which is immediately after the header region, is flanked, on one side in the radial direction, with a land area and a non-record area (mirror area) 111 and on the other side with a land area and another groove track. Consequently, reflection light from both side areas of this portion of the groove track becomes unbalanced. Moreover, the timing of start of recording on the groove track is concurrent with the push-pull tracking. It is thus expected that the recording and tracking state becomes unstable immediately after the start of recording.

FIG. 17 illustrates case 2-2 where user data is not recorded immediately after a header region on the optical disk. In case 2-2, a recording start point is set at a location that is apart from the end of the header region on the groove track by a predetermined distance (predetermined length T=α/2=N/2) in the circumferential direction of the disk. A recording end point is set at a location that is apart from the beginning of the header region by a predetermined distance (predetermined length T=α/2=N/2) in the circumferential direction. Thus, user data is recorded on the groove tracks. In this case, it is possible to avoid the configuration that the recording start portion of the groove track is adjacent to the non-record area (mirror area) 111 on one side alone in the radial direction. In addition, the timing of start of recording on the groove track is not concurrent with the push-pull tracking, and there is a time different therebetween. Thus, the recording and tracking state becomes stable immediately after the start of recording.

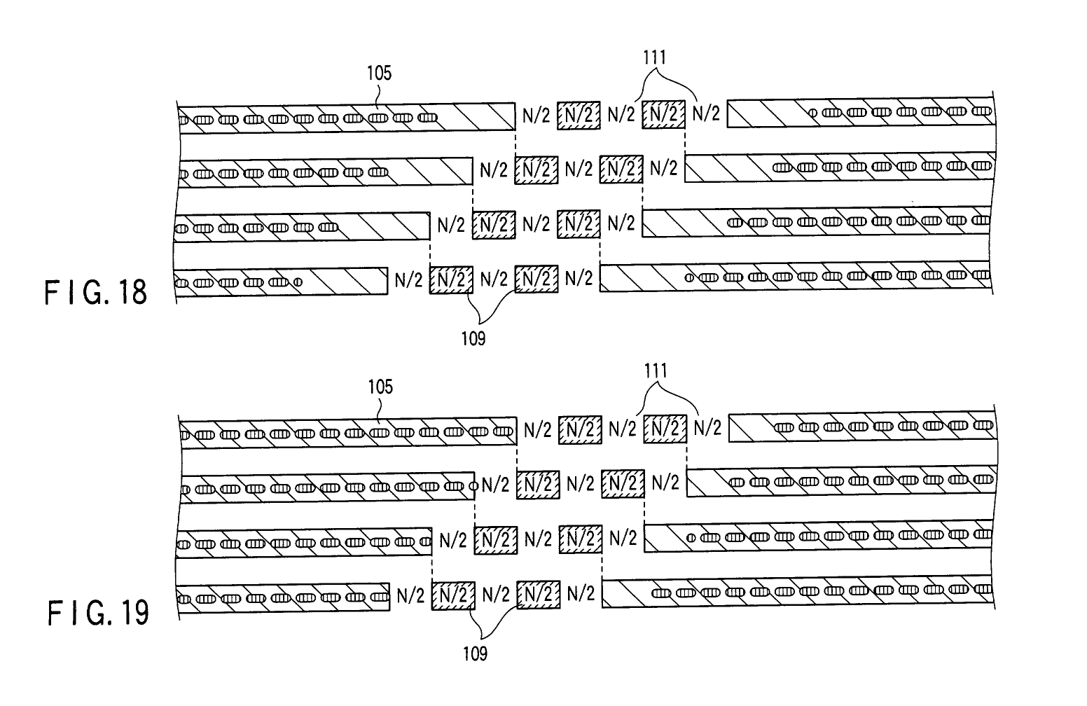

FIG. 18 illustrates case 2-3 where user data is not recorded immediately after a header region on the optical disk. In case 2-3, a recording start point is set at a location that is apart from the end of the header region on the groove track by a predetermined distance (predetermined length T=α=N) in the circumferential direction of the disk. A recording end point is set at a location that is apart from the beginning of the header region by a predetermined distance (predetermined length T=α=N) in the circumferential direction. Thus, user data is recorded on the groove tracks. In this case, too, it is possible to avoid the configuration that the recording start portion of the groove track is adjacent to the non-record area (mirror area) 111 on one side alone in the radial direction. In addition, the timing of start of recording on the groove track is not concurrent with the push-pull tracking, and there is a time different therebetween. Thus, the recording and tracking state becomes stable immediately after the start of recording. Furthermore, since the distance between the end of the header region and the recording start point is made greater than in case 2-2 (FIG. 17), tracking is made more stable.

FIG. 19 illustrates case 2-4 where user data is not recorded immediately after a header region on the optical disk. In case 2-4, a recording start point is set at a location that is apart from the end of the header region on the groove track by a predetermined distance (predetermined length T=α/2=N/2) in the circumferential direction of the disk. A recording end point is set at a location that is immediately before the beginning of the header region. Thus, user data is recorded on the groove tracks. In this case, it is possible to avoid the configuration that the recording start portion of the groove track is adjacent to the non-record area (mirror area) 111 on one side alone in the radial direction. In addition, the timing of start of recording on the groove track is not concurrent with the push-pull tracking, and there is a time different therebetween. Thus, the recording and tracking state becomes stable immediately after the start of recording. Furthermore, by determining the recording end point as described above, a decrease in recording capacity can be suppressed.

The structural features of the above-described optical disks according to the present invention will now be summarized.

(1) In an optical disk of the present invention, spiral groove tracks and spiral land grooves, each adjoining associated ones of the spiral groove tracks, are formed on a substrate. The ID information (header data) representing at least the number of an information record unit is recorded in advance on an intervening area on each of the groove track and land track, which intervening area splits each of the groove track and land track. The ID information is recorded in the form of prepits which are small recesses or projections. Intervening areas that split the groove tracks and land tracks are formed along the tracks at substantially regular intervals D (mm). A given track of one spiral turn on the disk has a length of M=D+α (mm) or M=D−α (mm) (M is a natural number; α is not zero and is a positive real number). The value α is substantially constant on the disk. Each of the ID information on the groove track and the ID information on the land track is divided into at least two. The divided ID information units on a given track, on the one hand, and those on the adjacent land track or groove track, on the other hand, are displaced and alternately arranged in a staggered fashion. The recording start point or recording end point on each of the groove track and land track is located within a distance from the intervening area that splits the groove track or land track, which distance is between α and 2α.

(2) In addition to the feature (1), each of the divided ID information units has substantially the same length, and the number of the information record unit contained in each of the divided ID information units is identical.

(3) In addition to the feature (1), the real number a is approximately double the physical length of each of the divided ID information units.

(4) In an optical disk of the present invention, spiral groove tracks are formed on a substrate. The ID information (header data) representing at least the number of an information record unit is recorded in advance on an intervening area on each groove track, which intervening area splits each groove track. The ID information is recorded in the form of prepits which are small recesses or projections. Intervening areas that split the groove tracks are formed along the tracks at substantially regular intervals D (mm). A given track of one spiral turn on the disk has a length of M=D+α (mm) or M=D−α (mm) (M is a natural number; α is not zero and is a positive real number). The value α is substantially constant on the disk. Each of the ID information on the groove track is divided into at least two. The divided ID information units on a given track, on the one hand, and those on the adjacent groove track, on the other hand, are displaced and alternately arranged in a staggered fashion. The recording start point or recording end point on each of the groove track is located within a distance from the intervening area that splits the groove track, which distance is between α and 2α.

(5) In addition to the feature (4), each of the divided ID information units has substantially the same length, and the number of the information record unit contained in each of the divided ID information units is identical.

(6) In addition to the feature (4), the real number α is approximately double the physical length of each of the divided ID information units.

(7) In an optical disk of the present invention, spiral groove tracks and spiral land grooves, each adjoining associated ones of the spiral groove tracks, are formed on a substrate. The ID information (header data) representing at least the number of an information record unit is recorded in advance on an intervening area on each of the groove track and land track, which intervening area splits each of the groove track and land track. The ID information is recorded in the form of prepits which are small recesses or projections. Intervening areas that split the groove tracks and land grooves are formed along the tracks at substantially regular intervals D (mm). A given track of one spiral turn on the disk has a length of M=D+α (mm) or M=D−α (mm) (M is a natural number; α is not zero and is a positive real number) The value α is substantially constant on the disk. Each of the ID information on the groove track and the ID information on the land track is divided into at least two. The divided ID information units on a given track, on the one hand, and those on the adjacent land track or groove track, on the other hand, are displaced and alternately arranged in a staggered fashion. The recording start point or recording end point on each of the groove track and land track is located within a distance from the intervening area that splits the groove track or land track, which distance is between (α−s) and α (s is a physical length of each divided ID information unit).

(8) In addition to the feature (7), each of the divided ID information units has substantially the same length, and the number of the information record unit contained in each of the divided ID information units is identical.

(9) In addition to the feature (7), the real number a is approximately double the physical length of each of the divided ID information units.

(10) In an optical disk of the present invention, spiral groove tracks are formed on a substrate. The ID information (header data) representing at least the number of an information record unit is recorded in advance on an intervening area on each groove track, which intervening area splits each groove track. The ID information is recorded in the form of prepits which are small recesses or projections. Intervening areas that split the groove tracks are formed along the tracks at substantially regular intervals D (mm). A given track of one spiral turn on the disk has a length of M=D+α (mm) or M=D−α (mm) (M is a natural number; a is not zero and is a positive real number). The value a is substantially constant on the disk. Each of the ID information on the groove track is divided into at least two. The divided ID information units on a given track, on the one hand, and those on the adjacent groove track, on the other hand, are displaced and alternately arranged in a staggered fashion. The recording start point or recording end point on each of the groove track is located within a distance from the intervening area that splits the groove track, which distance is between (α−s) and α (s is a physical length of each divided ID information unit).

(11) In addition to the feature (10), each of the divided ID information units has substantially the same length, and the number of the information record unit contained in each of the divided ID information units is identical.

(12) In addition to the feature (10), the real number α is approximately double the physical length of each of the divided ID information units.

The advantages of the optical disk according to the present invention will now be summarized.

According to the optical disk of this invention, user data (content data) is recorded on the spiral information recording groove tracks alone or on both the spiral information recording groove tracks and land tracks on the disk. The ID information is recorded on the intervening areas (header regions) that split the grooves (lands) in the form of prepits. The header regions are gradually displaced in the radial direction of the disk such that the header regions may form a spiral on the disk. Thereby, crosstalk of optical signals, which mixes signals from one recording layer into signals from the other recording layer, can be reduced. Moreover, the prepit header containing the ID information is divided into two prepit headers such that the prepit headers on one track and those on the adjacent track are displaced and alternately arranged in a staggered fashion. Thereby, the redundancy that results from the successively displaced arrangement of header regions on the tracks can be reduced, and the storage capacity for user data can be increased. Furthermore, the recording start points or recording end points on recording tracks are located not to adjoin the header regions, whereby stable tracking and recording can be performed.

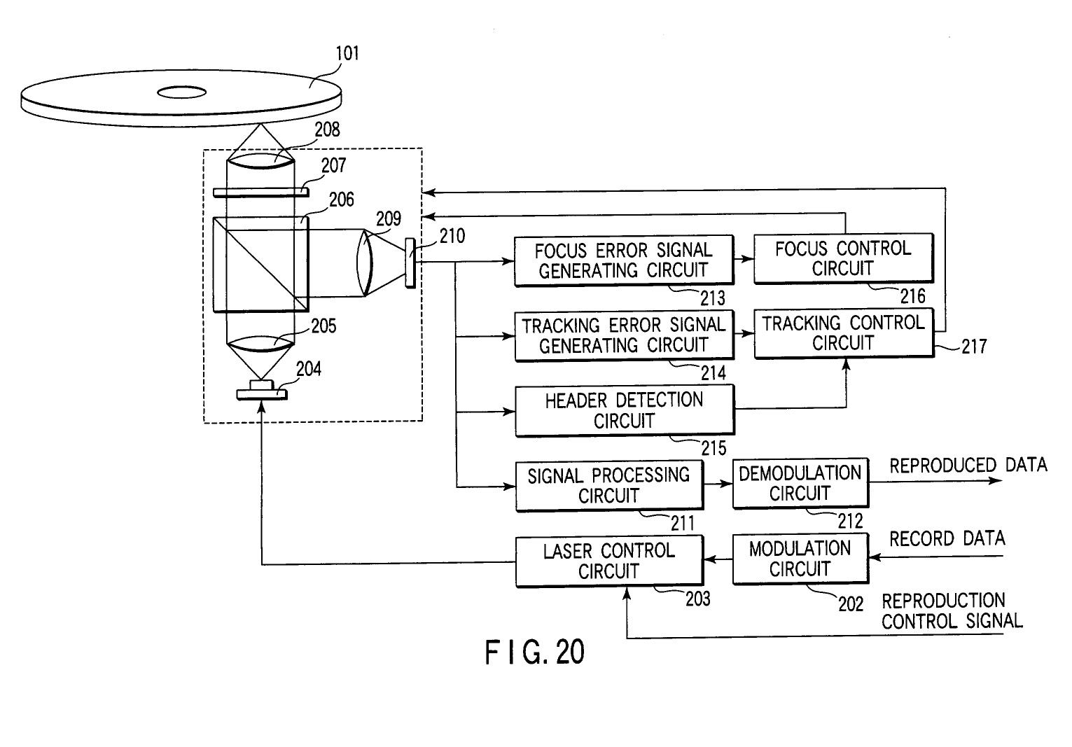

An optical disk drive for recording and reproducing data on/from the optical disks according to the above-described first and second embodiments will now be described. FIG. 20 schematically shows the structure of the optical disk drive. The optical disk drive records user data (content data) and reproduces it on/from a target record area on the optical disk according to the first embodiment (or second embodiment) by reading prepit headers 109 and 110 recorded on the disk and referring to the ID information stored on the prepit headers 109 (110).

As is shown in FIG. 20, the optical disk drive comprises a modulation circuit 202, a laser control circuit 203, a laser 204, a collator lens 205, a polarizing beam splitter (PBS) 206, a ¼ wavelength plate 207, an objective lens 208, a converging lens 209, a photodetector 210, a signal processing circuit 211, a demodulation circuit 212, a focus error signal generating circuit 213, a tracking error signal generating circuit 214, a header detection circuit 215, a focus control circuit 216, and a tracking control circuit 217.

Data recording by the optical disk drive will now be described. Record data (data symbol) is modulated into a predetermined channel bit sequence by the modulation circuit 202. The channel bit sequence corresponding to the record data is converted to a laser drive waveform by the laser control circuit 203. The laser control circuit 203 drives the laser 204 by pulses, thereby recording data corresponding to a desired bit sequence on the optical disk 101. A data recording laser beam emitted from the laser 204 is converted to a parallel beam by the collimator lens 205, and the parallel beam passes through the PBS 206. The beam emanating from the PBS 206 passes through the ¼ wavelength plate 207 and is focused by the objective lens 208 on the information recording surface of the optical disk 101. The focused beam is kept to have an optimal minimum beam spot on the recording surface by the focusing control of the focus control circuit 216 and by the tracking control of the tracking control circuit 217.

Next, data reproduction by the optical disk drive will now be described. Upon receiving a data reproduction instruction, the laser 204 emits a data recording laser beam. The laser beam from the laser 204 is converted to a parallel beam through the collimator lens 205. The parallel beam passes through the PBS 206. The beam emanating from the PBS 206 passes through the ¼ wavelength plate 207 and is focused by the objective lens 208 on the information recording surface of the optical disk 1. The focused beam is kept to have an optimal minimum beam spot on the recording surface by the focusing control of the focus control circuit 216 and by the tracking control of the tracking control circuit 217. At this time, the reproducing laser beam incident on the optical disk 101 is reflected by a reflection film or a reflective recording film within the information recording surface. The reflected beam enters the objective lens 208 in the reverse direction and changes into a parallel beam once again. The reflected beam passes through the ¼ wavelength plate 207 to have vertical polarization relative to the incident beam. The resultant beam is reflected by the PBS 206. The beam reflected by the PBS 206 is converged through the converging lens 209 and strikes on the photodetector 210. The photodetector 210 comprises, for example, a four-division photodetector. The beam incident on the photodetector 210 is photoelectrically converted to an electric signal, and the electric signal is amplified. The amplified signal is equalized and binarized by the signal processing circuit 211 and delivered to the demodulation circuit 212. The demodulation circuit 212 performs a demodulation operation matching with a predetermined modulation method and produces reproduced data.

Based on part of the electric signal output from the photodetector 210, the focus error signal generating circuit 213 generates a focus error signal. Similarly, based on part of the electric signal output from the photodetector 210, the tracking error signal generating circuit 214 generates a tracking error signal. In accordance with the focus error signal, the focus control circuit 216 controls the focusing of the beam spot. In accordance with the tracking error signal, the tracking control circuit 217 controls the tracking of the beam spot.

Furthermore, based on the electric signal from the photodetector 210, the header detection circuit 215 detects the prepit headers 109 and 110. Specifically, the header detection circuit 215 detects the prepit headers 109 and 110 representing the header data. The header data is the reproduced data output from the demodulation circuit at the time of the detection of the headers by the header detection circuit 215. Based on the header data, desired data is reproduced from a target record area or desired data is recorded on a target record area. In short, at the time of user data recording, the user data recording begins from the recording start point described with reference to FIGS. 10 to 19 and the user data recording is finished at the recording end point. Similarly, at the time of user data reproduction, the data read out from a region between the recording start point and recording end point described with reference to FIGS. 10 to 19 is output as user data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk comprising:
a prepit head data recording area surrounded by non-record areas in a radial direction and a circumferential direction of the optical disk; and
a data record track specified by prepit header data recorded on the prepit head data recording area.

2. An optical disk according to claim 1, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a groove track located after the header region and a land track located after the header region, the groove track and the land track being alternately arranged in the radial direction of the disk, each of the groove track and the land track forming one spiral turn on the disk,
the groove track of an n-th spiral turn is disposed to follow an end of a first header region of the n-th spiral turn of said plurality of header regions,
the land track of an (n+1)th spiral turn, which is radially adjacent to the groove track of the n-th spiral turn, is disposed to follow an end of a second header region of the (n+1)th spiral turn of said plurality of header regions, and the second header region is radially adjacent to the first header region,
the first header region and the second header region are displaced in the circumferential direction by a predetermined length T,
the prepit header data recording area included in the first header region and the non-record area included in the second header region are adjacent to each other in the radial direction,
the prepit header data recording area included in the second header region and the non-record area included in the first header region are adjacent to each other in the radial direction,
said groove track of an n-th spiral turn includes a data storing area having a data recording start point that is located away from the end of the first header region by said predetermined length T, and
said land track of an (n+1)th spiral turn includes a data storing area having a data recording start point that is located away from the end of the second header region by said predetermined length T.

3. An optical disk according to claim 1, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a groove track located after the header region and a land track located after the header region, the groove track and the land track being alternately arranged in the radial direction of the disk, each of the groove track and the land track forming one spiral turn on the disk,
the groove track of an n-th spiral turn is disposed to follow an end of a first header region of the n-th spiral turn of said plurality of header regions,
the land track of an (n+1)th spiral turn, which is radially adjacent to the groove track of the n-th spiral turn, is disposed to follow an end of a second header region of the (n+1)th spiral turn of said plurality of header regions, and the second header region is radially adjacent to the first header region,
the first header region and the second header region are displaced in the circumferential direction by a predetermined length T,
the prepit header data recording area included in the first header region and the non-record area included in the second header region are adjacent to each other in the radial direction,
the prepit header data recording area included in the second header region and the non-record area included in the first header region are adjacent to each other in the radial direction,
said groove track of an n-th spiral turn includes a data storing area having a data recording start point that is located away from the end of the first header region by a predetermined length 2T, and
said land track of an (n+1)th spiral turn includes a data storing area having a data recording start point that is located away from the end of the second header region by said predetermined length 2T.

4. An optical disk according to claim 1, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a plurality of groove tracks located after the header regions, the groove tracks being arranged in the radial direction of the disk with land areas interposed in an alternate fashion, each of the groove track and the land areas forming one spiral turn on the disk,
the groove track of an n-th spiral turn is disposed to follow an end of a first header region of the n-th spiral turn of said plurality of header regions,
the groove track of an (n+2)th spiral turn, which is radially adjacent to the groove track of the n-th spiral turn with the land area of an (n+1)th spiral turn interposed therebetween, is disposed to follow an end of a second header region of the (n+2)th spiral turn of said plurality of header regions, and the second header region is radially adjacent to the first header region with the land area of the (n+1)th spiral turn interposed therebetween,
the first header region and the second header region are displaced in the circumferential direction by a predetermined length T,
the prepit header data recording area included in the first header region and the non-record area included in the second header region are adjacent to each other in the radial direction, with the land area interposed therebetween,
the prepit header data recording area included in the second header region and the non-record area included in the first header region are adjacent to each other in the radial direction, with the land area interposed therebetween,
said groove track of an n-th spiral turn includes a data storing area having a data recording start point that is located away from the end of the first header region by said predetermined length T, and
said groove track of an (n+2)th spiral turn includes a data storing area having a data recording start point that is located away from the end of the second header region by said predetermined length T.

5. An optical disk according to claim 1, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a plurality of groove tracks located after the header regions, the groove tracks being arranged in the radial direction of the disk with land areas interposed in an alternate fashion, each of the groove track and the land areas forming one spiral turn on the disk,
the groove track of an n-th spiral turn is disposed to follow an end of a first header region of the n-th spiral turn of said plurality of header regions,
the groove track of an (n+2)th spiral turn, which is radially adjacent to the groove track of the n-th spiral turn with the land area of an (n+1)th spiral turn interposed therebetween, is disposed to follow an end of a second header region of the (n+2)th spiral turn of said plurality of header regions, and the second header region that is radially adjacent to the first header region with the land area of the (n+1)th spiral turn interposed therebetween,
the first header region and the second header region are displaced in the circumferential direction by a predetermined length T,
the prepit header data recording area included in the first header region and the non-record area included in the second header region are adjacent to each other in the radial direction, with the land area interposed therebetween,
the prepit header data recording area included in the second header region and the non-record area included in the first header region are adjacent to each other in the radial direction, with the land area interposed therebetween,
said groove track of an n-th spiral turn includes a data storing area having a data recording start point that is located away from the end of the first header region by a predetermined length 2T, and
said groove track of an (n+2)th spiral turn includes a data storing area having a data recording start point that is located away from the end of the second header region by said predetermined length 2T.

6. An optical disk drive for recording data on an optical disk having a prepit head data recording area surrounded by non-record areas in a radial direction and a circumferential direction of the optical disk, and a data record track specified by prepit header data recorded on the prepit head data recording area, the optical disk drive comprising:
a recording section configured to record data on the optical disk; and
a recording control section configured to record data by setting, as a data recording start point, a location on the data record track which is away from a beginning of the data record track by a predetermined length.

7. An optical disk drive according to claim 6, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a groove track located after the header region and a land track located after the header region, the groove track and the land track being alternately arranged in the radial direction of the disk, each of the groove track and the land track forming one spiral turn on the disk,
the groove track of an n-th spiral turn is disposed to follow an end of a first header region of the n-th spiral turn of said plurality of header regions,
the land track of an (n+1)th spiral turn, which is radially adjacent to the groove track of the n-th spiral turn, is disposed to follow an end of a second header region of the (n+1)th spiral turn of said plurality of header regions, and the second header region is radially adjacent to the first header region,
the first header region and the second header region are displaced in the circumferential direction by a predetermined length T,
the prepit header data recording area included in the first header region and the non-record area included in the second header region are adjacent to each other in the radial direction, and
the prepit header data recording area included in the second header region and the non-record area included in the first header region are adjacent to each other in the radial direction, and
wherein said recording control section of the optical disk drive effects data recording by setting, as a data recording start point, a location on the groove track of an n-th spiral turn which is away from the end of the first header region by said predetermined length T, and also effects data recording by setting, as a data recording start point, a location on the land track of an (n+1)th spiral turn which is away from the end of the second header region by said predetermined length T.

8. An optical disk drive according to claim 6, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a groove track located after the header region and a land track located after the header region, the groove track and the land track being alternately arranged in the radial direction of the disk, each of the groove track and the land track forming one spiral turn on the disk,
the groove track of an n-th spiral turn is disposed to follow an end of a first header region of the n-th spiral turn of said plurality of header regions,
the land track of an (n+1)th spiral turn, which is radially adjacent to the groove track of the n-th spiral turn, is disposed to follow an end of a second header region of the (n+1)th spiral turn of said plurality of header regions, and the second header region is radially adjacent to the first header region,
the first header region and the second header region are displaced in the circumferential direction by a predetermined length T,
the prepit header data recording area included in the first header region and the non-record area included in the second header region are adjacent to each other in the radial direction, and
the prepit header data recording area included in the second header region and the non-record area included in the first header region are adjacent to each other in the radial direction, and
wherein said recording control section of the optical disk drive effects data recording by setting, as a data recording start point, a location on the groove track of an n-th spiral turn which is away from the end of the first header region by a predetermined length 2T, and also effects data recording by setting, as a data recording start point, a location on the land track of an (n+1)th spiral turn which is away from the end of the second header region by said predetermined length 2T.

9. An optical disk drive according to claim 6, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a plurality of groove tracks located after the header regions, the groove tracks being arranged in the radial direction of the disk with land areas interposed in an alternate fashion, each of the groove track and the land areas forming one spiral turn on the disk,
the groove track of an n-th spiral turn is disposed to follow an end of a first header region of the n-th spiral turn of said plurality of header regions,
the groove track of an (n+2)th spiral turn, which is radially adjacent to the groove track of the n-th spiral turn with the land area of an (n+1)th spiral turn interposed therebetween, is disposed to follow an end of a second header region of the (n+2)th spiral turn of said plurality of header regions, and the second header region is radially adjacent to the first header region with the land area of the (n+1)th spiral turn interposed therebetween,
the first header region and the second header region are displaced in the circumferential direction by a predetermined length T,
the prepit header data recording area included in the first header region and the non-record area included in the second header region are adjacent to each other in the radial direction, with the land area interposed therebetween, and
the prepit header data recording area included in the second header region and the non-record area included in the first header region are adjacent to each other in the radial direction, with the land area interposed therebetween, and
wherein said recording control section of the optical disk drive effects data recording by setting, as a data recording start point, a location on the groove track of an n-th spiral turn which is away from the end of the first header region by said predetermined length T, and also effects data recording by setting, as a data recording start point, a location on the groove track of an (n+2)th spiral turn which is away from the end of the second header region by said predetermined length T.

10. An optical disk drive according to claim 6, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a plurality of groove tracks located after the header regions, the groove tracks being arranged in the radial direction of the disk with land areas interposed in an alternate fashion, each of the groove track and the land areas forming one spiral turn on the disk,
the groove track of an n-th spiral turn is disposed to follow an end of a first header region of the n-th spiral turn of said plurality of header regions,
the groove track of an (n+2)th spiral turn, which is radially adjacent to the groove track of the n-th spiral turn with the land area of an (n+1)th spiral turn interposed therebetween, is disposed to follow an end of a second header region of the (n+2)th spiral turn of said plurality of header regions, and the second header region that is radially adjacent to the first header region with the land area of the (n+1)th spiral turn interposed therebetween,
the first header region and the second header region are displaced in the circumferential direction by a predetermined length T,
the prepit header data recording area included in the first header region and the non-record area included in the second header region are adjacent to each other in the radial direction, with the land area interposed therebetween, and
the prepit header data recording area included in the second header region and the non-record area included in the first header region are adjacent to each other in the radial direction, with the land area interposed therebetween, and
wherein said recording control section of the optical disk drive effects data recording by setting, as a data recording start point, a location on the groove track which is away from the end of the associated header region by a predetermined length 2T, and also effects data recording by setting, as a data recording start point, a location on the groove track of an (n+2)th spiral turn which is away from the end of the second header region by said predetermined length 2T.

11. An optical disk drive for reproducing data from an optical disk having a prepit head data recording area surrounded by non-record areas in a radial direction and a circumferential direction of the optical disk, and a data record track specified by prepit header data recorded on the prepit head data recording area, the optical disk drive comprising:
a reproducing section configured to reproduce data from the optical disk; and
a reproduction control section configured to reproduce data by setting, as a data reproduction start point, a location on the data record track which is away from a beginning of the data record track by a predetermined length.

12. An optical disk drive according to claim 11, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a groove track located after the header region and a land track located after the header region, the groove track and the land track being alternately arranged in the radial direction of the disk, each of the groove track and the land track forming one spiral turn on the disk,
the groove track of an n-th spiral turn is disposed to follow an end of a first header region of the n-th spiral turn of said plurality of header regions,
the land track of an (n+1)th spiral turn, which is radially adjacent to the groove track of the n-th spiral turn, is disposed to follow an end of a second header region of the (n+1)th spiral turn of said plurality of header regions, and the second header region is radially adjacent to the first header region,
the first header region and the second header region are displaced in the circumferential direction by a predetermined length T,
the prepit header data recording area included in the first header region and the non-record area included in the second header region are adjacent to each other in the radial direction, and
the prepit header data recording area included in the second header region and the non-record area included in the first header region are adjacent to each other in the radial direction, and
wherein said reproduction control section of the optical disk drive effects data reproduction by setting, as a data reproduction start point, a location on the groove track of an n-the spiral turn which is away from the end of the first header region by said predetermined length T, and also effects data reproduction by setting, as a data reproduction start point, a location on the land track of an (n+1)th spiral turn which is away from the end of the second header region by said predetermined length T.

13. An optical disk drive according to claim 11, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a groove track located after the header region and a land track located after the header region, the groove track and the land track being alternately arranged in the radial direction of the disk, each of the groove track and the land track forming one spiral turn on the disk,
the groove track of an n-th spiral turn is disposed to follow an end of a first header region of the n-th spiral turn of said plurality of header regions,
the land track of an (n+1)th spiral turn, which is radially adjacent to the groove track of the n-th spiral turn, is disposed to follow an end of a second header region of the (n+1)th spiral turn of said plurality of header regions, and the second header region is radially adjacent to the first header region,
the first header region and the second header region are displaced in the circumferential direction by a predetermined length T,
the prepit header data recording area included in the first header region and the non-record area included in the second header region are adjacent to each other in the radial direction, and
the prepit header data recording area included in the second header region and the non-record area included in the first header region are adjacent to each other in the radial direction, and
wherein said reproduction control section of the optical disk drive effects data reproduction by setting, as a data reproduction start point, a location on the groove track of an n-th spiral turn which is away from the end of the first header region by a predetermined length 2T, and also effects data reproduction by setting, as a data reproduction start point, a location on the land track of an (n+1)th spiral turn which is away from the end of the second header region by said predetermined length 2T.

14. An optical disk drive according to claim 11, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a plurality of groove tracks located after the header regions, the groove tracks being arranged in the radial direction of the disk with land areas interposed in an alternate fashion, each of the groove track and the land areas forming one spiral turn on the disk,
the groove track of an n-th spiral turn is disposed to follow an end of a first header region of the n-th spiral turn of said plurality of header regions,
the groove track of an (n+2)th spiral turn, which is radially adjacent to the groove track of the n-th spiral turn with the land area of an (n+1)th spiral turn interposed therebetween, is disposed to follow an end of a second header region of the (n+2)th spiral turn of said plurality of header regions, and the second header region is radially adjacent to the first header region with the land area of the (n+1)th spiral turn interposed therebetween,
the first header region and the second header region are displaced in the circumferential direction by a predetermined length T,
the prepit header data recording area included in the first header region and the non-record area included in the second header region are adjacent to each other in the radial direction, with the land area interposed therebetween, and
the prepit header data recording area included in the second header region and the non-record area included in the first header region are adjacent to each other in the radial direction, with the land area interposed therebetween, and
wherein said reproducing control section of the optical disk drive effects data reproduction by setting, as a data reproduction start point, a location on the groove track of an n-th spiral turn which is away from the end of the first header region by said predetermined length T, and also effects data reproduction by setting, as a data reproduction start point, a location on the groove track of an (n+2)th spiral turn which is away from the end of the second header region by said predetermined length T.

15. An optical disk drive according to claim 11, wherein the optical disk includes a plurality of header regions each comprising a plurality of said prepit head data recording areas and a plurality of said non-record areas arranged on both sides of each prepit head data recording area in the circumferential direction,
the optical disk includes a plurality of said data record tracks comprising a plurality of groove tracks located after the header regions, the groove tracks being arranged in the radial direction of the disk with land areas interposed in an alternate fashion, each of the groove track and the land areas forming one spiral turn on the disk,
the groove track of an n-th spiral turn is disposed to follow an end of a first header region of the n-th spiral turn of said plurality of header regions,
the groove track of an (n+2)th spiral turn, which is radially adjacent to the groove track of the n-th spiral turn with the land area of an (n+1)th spiral turn interposed therebetween, is disposed to follow an end of a second header region of the (n+2)th spiral turn of said plurality of header regions, and the second header region that is radially adjacent to the first header region with the land area of the (n+1)th spiral turn interposed therebetween,
the first header region and the second header region are displaced in the circumferential direction by a predetermined length T,
the prepit header data recording area included in the first header region and the non-record area included in the second header region are adjacent to each other in the radial direction, with the land area interposed therebetween,
the prepit header data recording area included in the second header region and the non-record area included in the first header region are adjacent to each other in the radial direction, with the land area interposed therebetween,
wherein said reproduction control section of the optical disk drive effects data reproduction by setting, as a data reproduction start point, a location on the groove track which is away from the end of the associated header region by a predetermined length 2T, and also effects data reproduction by setting, as a data reproduction start point, a location on the groove track of an (n+2)th spiral turn which is away from the end of the second header region by said predetermined length 2T.
